(19) United States
(12) Patent Application Publication
(10) Pub. No.: US 2026/0307927 A1
(43) Pub. Date: Oct. 8, 2026

(54) SHEET MEMBER TRANSFER DEVICE, ELECTRODE BODY DISASSEMBLY DEVICE, AND SHEET MEMBER TRANSFER METHOD

(71) Applicant: Prime Planet Energy & Solutions, Inc., Tokyo (JP)

(72) Inventors: Yozo UCHIDA, Toyota-shi (JP); Keita YAMADA, Koriyama-shi (JP); Kazuhiko HASHIMOTO, Koriyama-shi (JP); Masayuki KUROTAKI, Koriyama-shi (JP); Taku KITAYAMA, Koriyama-shi (JP)

(21) Appl. No.: 19/640,425

(22) Filed: Apr. 7, 2026

(30) Foreign Application Priority Data
Apr. 8, 2025 (JP) 2025-063651

(51) Int. Cl. B65H 20/02; H01M 10/54

(52) U.S. Cl. CPC B65H 20/02; H01M 10/54; B65H 2403/20; B65H 2404/147; B65H 2404/74

(57) ABSTRACT

An electrode body disassembly device includes a pair of first nip rollers that nip a strip-shaped first separator sheet and a transfer motor that rotates the first nip roller and transfers the first separator sheet. The first nip roller includes a wire. The wire extends in a tangential direction of the first nip roller and in a downstream direction in a transfer direction of the first separator sheet.

### CROSS REFERENCE TO RELATED APPLICATIONS

The present application claims priority from Japanese Patent Application No. 2025-063651 filed on Apr. 8, 2025, which is incorporated by reference herein in its entirety.

### BACKGROUND

The present invention relates to a sheet member transfer device, an electrode body disassembly device, and a sheet member transfer method.

Japanese Patent Application Publication No. 2007-165136 discloses a method of recycling lithium-ion secondary batteries in order to collect rare resources such as nickel from used lithium-ion secondary batteries. In the method disclosed in this publication, a wound electrode group for a battery, in which positive and negative electrodes are wound with a separator therebetween, is separated into a positive electrode, a negative electrode and a separator, and each is wound by a roller or the like. Accordingly, positive electrodes and negative electrodes using rare resources are collected.

Incidentally, the inventors wish to improve the time efficiency for collecting sheet members.

### SUMMARY

A sheet member transfer device proposed here comprises a pair of nip rollers that nip a strip-shaped sheet member and a drive device that rotates the nip roller and transfers the sheet member. The nip roller includes a guide member that extends in a tangential direction of the nip roller and in a downstream direction in a transfer direction, in which the sheet member is transferred.

According to the sheet member transfer device, it is possible to improve the time efficiency for collecting sheet members.

### BRIEF DESCRIPTION OF THE DRAWINGS

FIG. 1 is a cross-sectional view showing an internal structure of an electricity storage device 200 according to one embodiment;

FIG. 2 is a partially cutaway perspective view of an electrode body 1 according to one embodiment;

FIG. 3 is a perspective view of an electrode body disassembly device 10;

FIG. 4 is a perspective view of an electrode body accommodation part 20;

FIG. 5 is a plan view of the electrode body accommodation part 20;

FIG. 6 is a perspective view of the periphery of the electrode body accommodation part 20;

FIG. 7 is a partial cross-sectional view of the periphery of the electrode body accommodation part 20 when an air cylinder 24b is extended;

FIG. 8 is a perspective view of a first separation device 50;

FIG. 9 is a perspective view showing a first transfer unit 40;

FIG. 10 is a cross-sectional view of a first nip roller 41 and a pulley 44;

FIG. 11 is a perspective view of the first separation device 50 in a state where a scraper is inserted into a bent portion R1a of a transfer path R1;

FIG. 12 is a front view of the first transfer unit 40 when a first separator sheet 2 is interposed between the first nip rollers 41;

FIG. 13 is a perspective view of a second separation device 150;

FIG. 14 is a perspective view of the second separation device 150 in a state where a peeling roller 153 is lowered;

FIG. 15 is a flowchart showing a process of disassembling the electrode body 1;

FIG. 16 is a perspective view of the first transfer unit 40 and the first separation device while transferring the first separator sheet 2; and

FIG. 17 is a front view of a second transfer unit 140 and the second separation device while transferring a second separator sheet 4.

### DETAILED DESCRIPTION

Hereinafter, an electrode body disassembly device according to one embodiment will be described. Here, it should be noted that the embodiments described here are, of course, not intended to particularly limit the present invention. In the following, members and components that perform the same operations will be denoted with the same reference numerals, and redundant descriptions will be appropriately omitted or simplified.

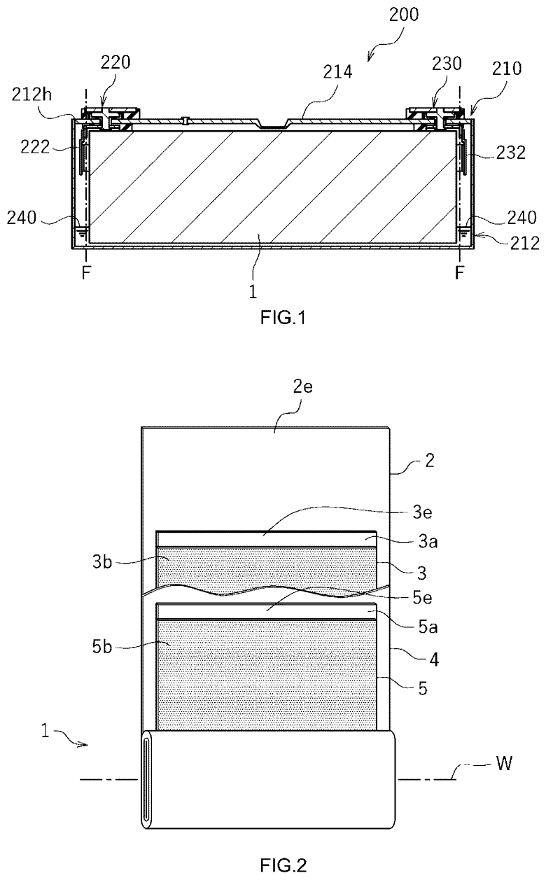

FIG. 1 is a cross-sectional view showing an internal structure of an electricity storage device 200 according to one embodiment. As shown in FIG. 1, the electricity storage device 200 includes a case 210, a positive electrode terminal 220, a negative electrode terminal 230, an electrolytic solution 240, and an electrode body 1. Here, the electricity storage device 200 is a non-aqueous electrolytic solution secondary battery, for example, a lithium-ion secondary battery. The electricity storage device 200 is configured such that the electrode body 1 and the electrolytic solution 240 are accommodated in the case 210 to which the positive electrode terminal 220 and the negative electrode terminal 230 are attached. Here, in this specification, the term “electricity storage device” refers to all devices that can be repeatedly charged and discharged, and is a concept including secondary batteries such as lithium-ion secondary batteries and nickel-metal hydride batteries, and capacitors such as lithium-ion capacitors and electric double layer capacitors.

The case 210 accommodates the electrode body 1 and the electrolytic solution 240. Here, the case 210 has a flat and bottomed rectangular parallelepiped (square) outer shape. However, the shape of the case 210 is not limited thereto. The material of the case 210 may be the same as those conventionally used, and is not particularly limited. The case 210 includes a rectangular cylindrical case main body 212 having an opening 212h and a sealing plate 214 that closes the opening 212h. The case 210 is integrated by joining (for example, welding and joining) the sealing plate 214 to the periphery of the opening 212h of the case main body 212. The case 210 is airtightly sealed (hermetically sealed). The sealing plate 214 is a plate-shaped member that seals the opening 212h. The sealing plate 214 has a substantially rectangular shape in a plan view. The positive electrode terminal 220 and the negative electrode terminal 230 are provided on the sealing plate 214.

The positive electrode terminal 220 is, for example, a terminal made of aluminum or an aluminum alloy. The positive electrode terminal 220 is electrically connected to the positive electrode sheet 5 (refer to FIG. 2) of the electrode body 1 to be described below via a positive electrode current collector 222 inside the case 210. The negative electrode terminal 230 is, for example, a terminal made of copper or a copper alloy. The negative electrode terminal 230 is electrically connected to the negative electrode sheet 3 (refer to FIG. 2) of the electrode body 1 to be described below via a negative electrode current collector 232 inside the case 210.

The electrolytic solution 240 is accommodated inside the case 210 together with the electrode body 1. A part of the electrolytic solution 240 is impregnated into the electrode body 1. The electrolytic solution 240 is, for example, a non-aqueous electrolytic solution containing a non-aqueous solvent (organic solvent) and a supporting salt (an electrolyte salt, for example, a lithium salt or a sodium salt). Examples of non-aqueous solvents include carbonates such as ethylene carbonate, dimethyl carbonate, and ethyl methyl carbonate. Examples of supporting salts include fluorine-containing lithium salts such as lithium hexafluorophosphate (LiPF₆). The electrolytic solution 240 is typically in a liquid form, but may be in a gel form.

### Configuration of Electrode Body

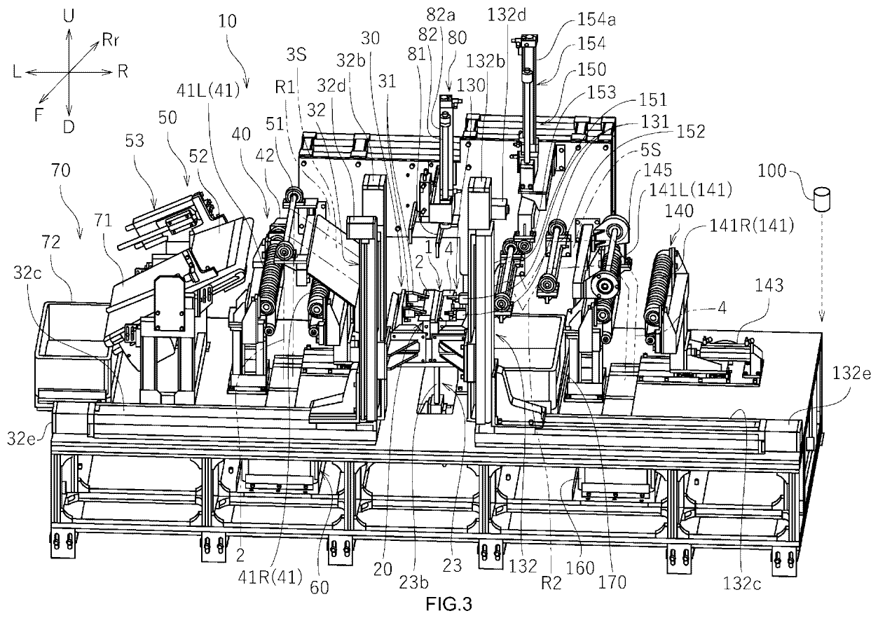

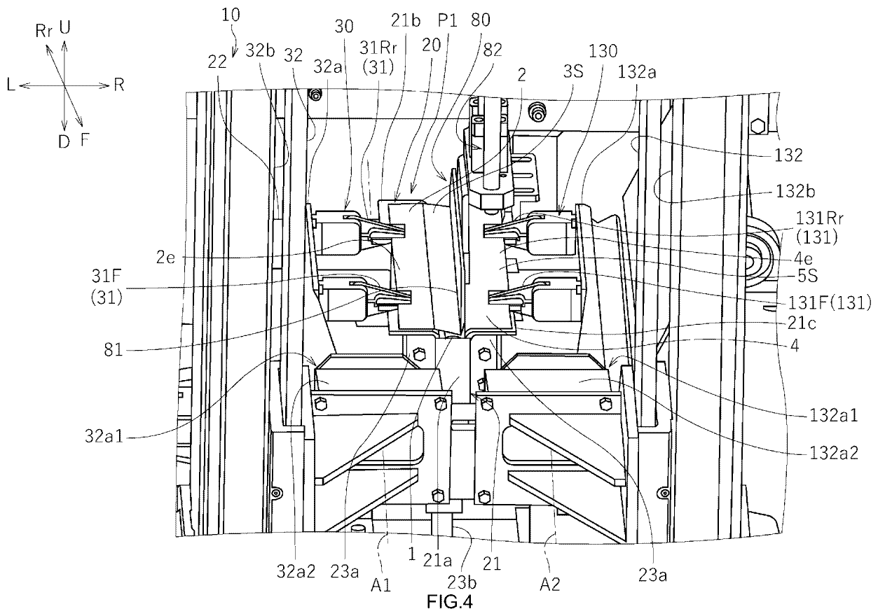

FIG. 2 is a partially cutaway perspective view of the electrode body 1 according to one embodiment. The electrode body 1 is an object to be disassembled by an electrode body disassembly device 10 according to the present embodiment (refer to FIG. 3). The electrode body 1 is removed from the case 210 (refer to FIG. 1) of the electricity storage device 200. Various methods of removing the electrode body 1 from the electricity storage device 200 have been proposed, and there are no particular limitations.

As shown in FIG. 2, the electrode body 1 is formed by laminating a strip-shaped first separator sheet 2, a strip-shaped negative electrode sheet 3, a strip-shaped second separator sheet 4, and a strip-shaped positive electrode sheet 5 in that order and winding them in a predetermined winding direction. The electrode body 1 is a so-called wound electrode body. Here, the electrode body 1 is wound in a direction in which the first separator sheet 2, the negative electrode sheet 3, the second separator sheet 4, and the positive electrode sheet 5 are arranged in that order from the outermost periphery. The first separator sheet 2 and the second separator sheet 4 are formed to be longer in the longitudinal direction (circumferential direction of winding) than the negative electrode sheet 3 and the positive electrode sheet 5. The winding end portion of the electrode body 1 is composed of the first separator sheet 2 and the second separator sheet 4. The first separator sheet 2 and the second separator sheet 4 are examples of the electrode member in the present invention.

The first separator sheet 2 and the second separator sheet 4 are formed of, for example, a porous resin sheet having required heat resistance and through which an electrolyte can pass. The materials of the first separator sheet 2 and the second separator sheet 4 are not particularly limited. The first separator sheet 2 and the second separator sheet 4 are interposed between the positive electrode sheet 5 and the negative electrode sheet 3, and insulate the positive electrode sheet 5 and the negative electrode sheet 3.

As shown in FIG. 2, the negative electrode sheet 3 includes a negative electrode collection foil 3a and a negative electrode active material layer 3b formed on the negative electrode collection foil 3a. The negative electrode sheet 3 is a member in which the negative electrode active material layer 3b containing a negative electrode active material is formed on the surface of the negative electrode collection foil 3a. Here, the negative electrode collection foil 3a is composed of a copper foil having a predetermined width and thickness. The negative electrode active material is a material, such as natural graphite, that can occlude lithium ions during charging and, and during discharging, release the lithium ions occluded during charging. In addition to natural graphite, generally, various negative electrode active materials have been proposed, and there are no particular limitations. When the electricity storage device 200 (refer to FIG. 1) is a device other than a lithium-ion secondary battery, the negative electrode sheet 3 may include various negative electrode collection foils 3a and negative electrode active material layers 3b according to the type of the electricity storage device 200.

The positive electrode sheet 5 includes a positive electrode collection foil 5a and a positive electrode active material layer 5b formed on the positive electrode collection foil 5a. The positive electrode sheet 5 is a member in which the positive electrode active material layer 5b containing a positive electrode active material is formed on the surface of the positive electrode collection foil 5a. Here, the positive electrode collection foil 5a is composed of an aluminum foil having a predetermined width and thickness. The positive electrode active material is a material, such as a lithium transition metal composite material, that can release lithium ions during charging and absorb lithium ions during discharging. In addition to the lithium transition metal composite material, generally, various positive electrode active materials have been proposed, and there are no particular limitations. When the electricity storage device 200 (refer to FIG. 1) is a device other than a lithium-ion secondary battery, the positive electrode sheet 5 may include various positive electrode collection foils 5a and positive electrode active material layers 5b according to the type of the electricity storage device 200.

The configuration of the electrode body 1 has been described above. Incidentally, for example, in a procedure of recycling used secondary batteries, metals (so-called rare metals) such as nickel, cobalt, and manganese may be collected. When a secondary battery is recycled, for example, the electrode body is separated into a sheet-like negative electrode, a positive electrode and a separator (hereinafter collectively referred to as a “sheet member”), and a sheet member is then interposed between nip rollers, and transferred by the rotation of the nip rollers. Because the sheet member has a relatively thin thickness, it can be caught in the rotation of the transferring nip rollers. In this case, the sheet member is not transferred as desired, and the recycling step stops midway. Therefore, the time efficiency for collecting sheet members becomes relatively low. The inventors thought that, if a guide member that prevented the sheet member from being caught was provided in the nip roller, the sheet member could be continuously transferred, and the time efficiency for collecting would be improved.

### Outline of Electrode Body Disassembly Device

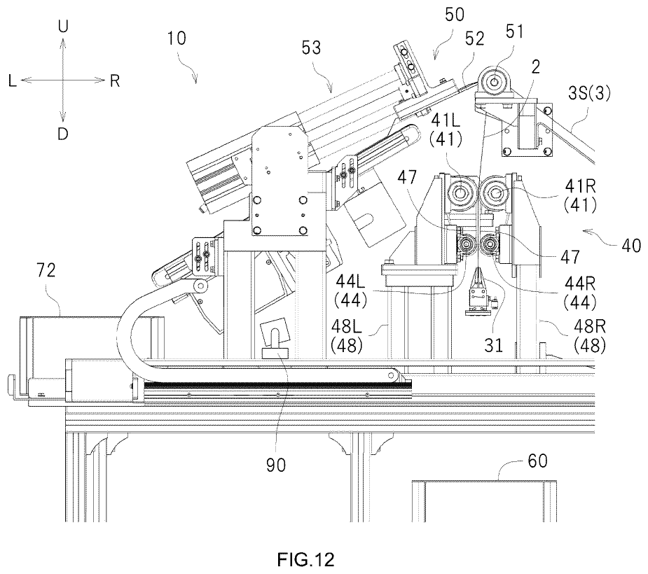

FIG. 3 is a perspective view of the electrode body disassembly device 10. Hereinafter, for convenience, the left to right direction in FIG. 3 will be referred to as a left to right direction, and the depth direction in FIG. 3 will be referred to as a front to rear direction. In the drawings, the front, rear, left, right, up and down are represented by the symbols F, Rr, L, R, U, and D. As shown in FIG. 3, the electrode body disassembly device 10 includes an electrode body accommodation part 20, a first gripping unit 30, a first transfer unit 40, a first separation device 50, a first separator collection unit 60, a negative electrode sheet collection unit 70, a second gripping unit 130, a second transfer unit 140, a second separation device 150, a second separator collection unit 160, a positive electrode sheet collection unit 170, a positive and negative electrode separation device 80, a static eliminator 90 (refer to FIG. 12), and a control device 100.

The electrode body 1 before disassembly is set in the electrode body accommodation part 20. The electrode body disassembly device 10 is configured to unwind the wound electrode body 1 by pulling the first separator sheet 2 of the electrode body 1 and also pulling the second separator sheet 4. In the procedure of unwinding the electrode body 1, the electrode body 1 rotates approximately about the winding axis W (refer to FIG. 2) inside the electrode body accommodation part 20.

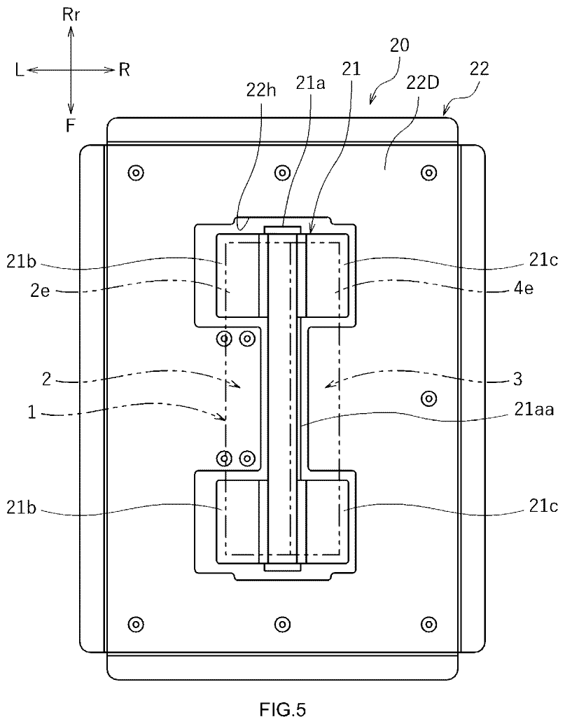

The first gripping unit 30 grips the first outer end 2e of the first separator sheet 2 (refer to FIG. 4) that has protruded outside the electrode body accommodation part 20. The negative electrode sheet 3 (refer to FIG. 2) is attached to the first separator sheet 2. Since the negative electrode sheet 3 is shorter in the longitudinal direction than the first separator sheet 2, the winding end portion of a laminate sheet of the first separator sheet 2 and the negative electrode sheet 3 (hereinafter referred to as a negative electrode laminate sheet 3S, refer to FIG. 4) is composed of only the first separator sheet 2. The first gripping unit 30 grips and moves the first outer end 2e of the first separator sheet 2 in the initial stage of unwinding the electrode body 1, and attaches the first separator sheet 2 to the first transfer unit 40. In the present embodiment, the first gripping unit 30 is disposed on the left side of the electrode body accommodation part 20.

The first transfer unit 40 transfers the first separator sheet 2 by nipping the first separator sheet 2 between a pair of first nip rollers 41 and rotating the pair of first nip rollers 41. The first transfer unit 40 is disposed further to the left side of the first gripping unit 30. The first separation device 50 separates the first separator sheet 2 and the negative electrode sheet 3 at a position upstream (on the side of the electrode body accommodation part 20) from the first transfer unit 40 on a transfer path R1 of the first separator sheet 2. Therefore, the first transfer unit 40 transfers only the first separator sheet 2 with the pair of first nip rollers 41. The first separator sheet 2 is sent to the first separator collection unit 60 by the first transfer unit 40. The negative electrode sheet 3 separated from the first separator sheet 2 advances as the first separator sheet 2 is transferred, and is collected in the negative electrode sheet collection unit 70 disposed downstream from the first separation device 50.

The second gripping unit 130 grips a second outer end 4e (refer to FIG. 4) of the second separator sheet 4 that has protruded outside the electrode body accommodation part 20. The positive electrode sheet 5 (refer to FIG. 1) is attached to the second separator sheet 4. Since the positive electrode sheet 5 is shorter in the longitudinal direction than the second separator sheet 4, the winding end portion of a laminate sheet of the second separator sheet 4 and the positive electrode sheet 5 (hereinafter referred to as a positive electrode laminate sheet 5S, refer to FIG. 4) is composed of only the second separator sheet 4. The second gripping unit 130 grips and moves the second outer end 4e of the second separator sheet 4 in the initial stage of unwinding the electrode body 1, and attaches the second separator sheet 4 to the second transfer unit 140. In the present embodiment, the second gripping unit 130 is disposed on the right side of the electrode body accommodation part 20.

The second transfer unit 140 transfers the second separator sheet 4 by nipping the second separator sheet 4 between a pair of second nip rollers 141 and rotating the pair of second nip rollers 141. The second transfer unit 140 is disposed further to the right side of the second gripping unit 130. The second separation device 150 separates the second separator sheet 4 and the positive electrode sheet 5 at a position upstream (on the side of the electrode body accommodation part 20) from the second transfer unit 140 on a transfer path R2 of the second separator sheet 4. Therefore, the second transfer unit 140 transfers only the second separator sheet 4 with the pair of second nip rollers 141. The second separator sheet 4 is sent to the second separator collection unit 160 by the second transfer unit 140. The positive electrode sheet 5 separated from the second separator sheet 4 falls into the positive electrode sheet collection unit 170 disposed below the second separation device 150.

The positive and negative electrode separation device 80 assists with separation into the negative electrode laminate sheet 3S and the positive electrode laminate sheet 5S when the first gripping unit 30 pulls the negative electrode laminate sheet 3S and the second gripping unit 130 pulls the positive electrode laminate sheet 5S. The positive and negative electrode separation device 80 assists with separation of the electrode body 1 into the negative electrode laminate sheet 3S and the positive electrode laminate sheet 5S by inserting a center scraper 81 between the negative electrode laminate sheet 3S and the positive electrode laminate sheet 5S. The positive and negative electrode separation device 80 is provided above the electrode body accommodation part 20.

### Electrode Body Accommodation Part

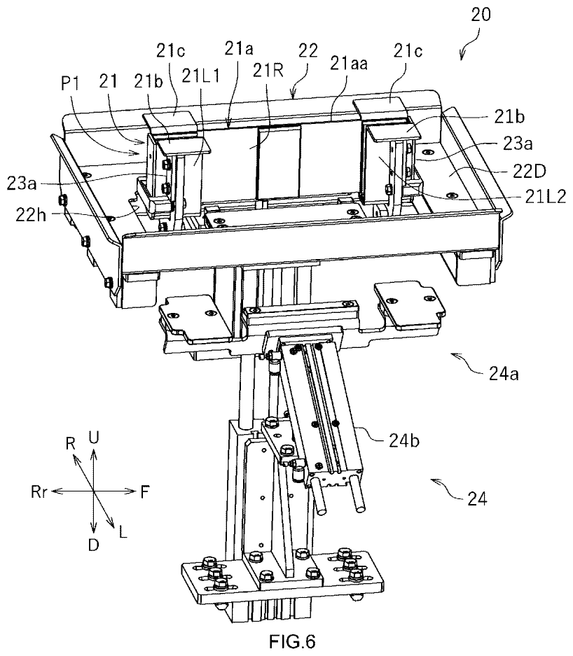

FIG. 4 is a perspective view of the electrode body accommodation part 20. As shown in FIG. 4, the electrode body accommodation part 20 includes a holding jig 21, a rotation box 22 (refer to FIG. 5 and FIG. 6), a jig lowering device 23 (refer to FIG. 3), and an electrode body support device 24 (refer to FIG. 6).

The holding jig 21 holds the electrode body 1 at a stage before the first outer end 2e is pulled by the first gripping unit 30, and the second outer end 4e is pulled by the second gripping unit 130. The holding jig 21 is a jig having an open side and capable of accommodating the electrode body 1. In the present embodiment, the holding jig 21 has an opening on the upper surface. The holding jig 21 includes a holding part 21a, a first placement part 21b, and a second placement part 21c.

The holding part 21a is a case capable of accommodating the electrode body 1. FIG. 5 is a plan view of the electrode body accommodation part 20. As shown in FIG. 5, the holding part 21a has an opening on the upper surface. In the present embodiment, the holding part 21a has a length in the left to right direction that is shorter than the length in the front to rear direction. The holding part 21a holds the electrode body 1 such that the winding axis W (refer to FIG. 1) is oriented substantially in the front to rear direction. That is, the width direction of the electrode body 1 accommodated in the holding part 21a substantially matches the front to rear direction of the holding part 21a. FIG. 6 is a perspective view of the periphery of the electrode body accommodation part 20. As shown in FIG. 6, the holding part 21a includes a right side surface 21R, a first left side surface 21L1, and a second left side surface 21L2. The right side surface 21R is a side surface that extends in the front to rear direction and upward. The first left side surface 21L1 and the second left side surface 21L2 are side surfaces that are positioned to the left side of the right side surface 21R and extend in the front to rear direction and upward. The first left side surface 21L1 is formed on the rear end side of the holding part 21a. The second left side surface 21L2 is formed on the front end side of the holding part 21a. A peripheral part 21aa of the opening of the holding part 21a has a substantially C-shape in a plan view. The length of the first left side surface 21L1 in the front to rear direction is substantially the same as the length of the first placement part 21b in the front to rear direction. The length of the second left side surface 21L2 in the front to rear direction is substantially the same as the length of the second placement part 21c in the front to rear direction. When the electrode body 1 (refer to FIG. 1) is accommodated in the holding part 21a, the electrode body 1 is held between the first left side surface 21L1 and the second left side surface 21L2 in a state where it is exposed to the outside of the holding jig 21.

As shown in FIG. 5, the first placement part 21b is a portion on which the first outer end 2e of the first separator sheet 2 (the negative electrode laminate sheet 3S (refer to FIG. 4)) is placed. As shown in FIG. 6, the first placement part 21b extends to the left side from the upper ends of the first left side surface 21L1 and the second left side surface 21L2. Here, the first placement part 21b may be provided not only at the front end and the rear end of the peripheral part 21aa, but also between the front end and the rear end of the peripheral part 21aa.

As shown in FIG. 5, the second placement part 21c is a portion on which the second outer end 4e of the second separator sheet 4 (the positive electrode laminate sheet 5S (refer to FIG. 4)) is placed. As shown in FIG. 6, the second placement part 21c extends from the upper end of the right side surface 21R to the right side. The second placement part 21c extends from the front end side and the rear end side of the right side surface 21R. In addition, the second placement part 21c may be provided not only on the front end side and the rear end side of the right side surface 21R, but also between the front end and the rear end of the right side surface 21R.

As shown in FIG. 4, the rotation box 22 is a box-shaped member in which the electrode body 1 released from the holding jig 21 is accommodated. The rotation box 22 has an open upper surface. The holding jig 21 is set at a predetermined position of the rotation box 22. A positioning member 23a that determines the set position of the holding jig 21 will be described when the jig lowering device 23 is described. When the position of the holding jig 21 is determined, the positions of the first outer end 2e of the first separator sheet 2 (the negative electrode laminate sheet 3S) and the second outer end 4e of the second separator sheet 4 (the positive electrode laminate sheet 5S) are determined. The electrode body 1 released from the holding jig 21 rotates approximately about the winding axis W (refer to FIG. 1) inside the rotation box 22 as the first separator sheet 2, the negative electrode sheet 3, the second separator sheet 4, and the positive electrode sheet 5 are unwound. The length of the rotation box 22 in the left to right direction is longer than the rotation diameter of the electrode body 1 such that the electrode body 1 is allowed to move in the left to right direction.

As shown in FIG. 5, on a bottom surface 22D of the rotation box 22, a through-hole 22h that penetrates in the up and down direction is formed. The through-hole 22h has a substantially H-shape in a plan view. The through-hole 22h is formed to be slightly larger than the holding jig 21 in a plan view. Therefore, the holding jig 21 can pass through the through-hole 22h, and can move below and above the bottom surface 22D.

The jig lowering device 23 shown in FIG. 4 is a device that moves the holding jig 21 between an accommodation position P1 and a separation position P2 (refer to FIG. 8). The accommodation position P1 is a position where the electrode body 1 is accommodated in the holding part 21a. In the present embodiment, the accommodation position P1 is a position of the holding jig 21 when the bottom surface of the holding part 21a is substantially flush with the bottom surface 22D of the rotation box 22. The separation position P2 is a position where the holding part 21a is separated from the electrode body 1. In the present embodiment, the separation position P2 is a position below the rotation box 22. In a state where the holding jig 21 is positioned at the accommodation position P1, the first outer end 2e is gripped by the first gripping unit 30 and the second outer end 4e is gripped by the second gripping unit 130, the holding jig 21 is then lowered below the rotation box 22 (refer to FIG. 8, in FIG. 8, the holding jig 21 is lowered). Accordingly, the holding jig 21 is moved from the accommodation position P1 to the separation position P2. The jig lowering device 23 includes the positioning member 23a that supports the holding jig 21 and determines a set position of the holding jig 21, and an air cylinder 23b that supports the positioning member 23a and expands and contracts in the up and down direction (refer to FIG. 3). However, the configuration of the jig lowering device 23 is not particularly limited.

As shown in FIG. 6, the electrode body support device 24 is disposed diagonally downward to the left of the rotation box 22. The electrode body support device 24 is a device that supports the electrode body 1 together with the rotation box 22 after the electrode body 1 (refer to FIG. 5) is released from the holding jig 21. The electrode body support device 24 includes a support member 24a and an air cylinder 24b.

The support member 24a has substantially the same outer shape as the through-hole 22h in a plan view (refer to FIG. 5). The support member 24a has a slightly smaller outer shape than the through-hole 22h in a plan view.

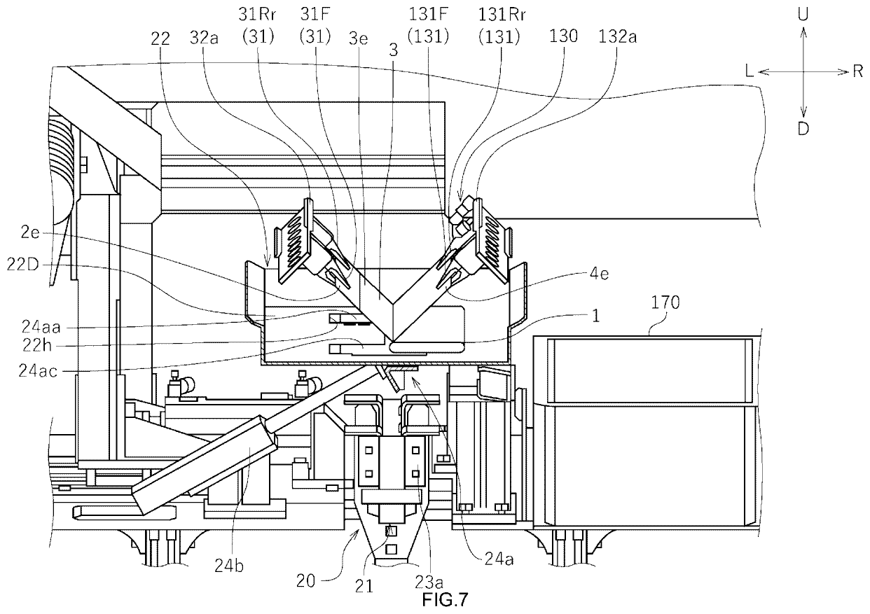

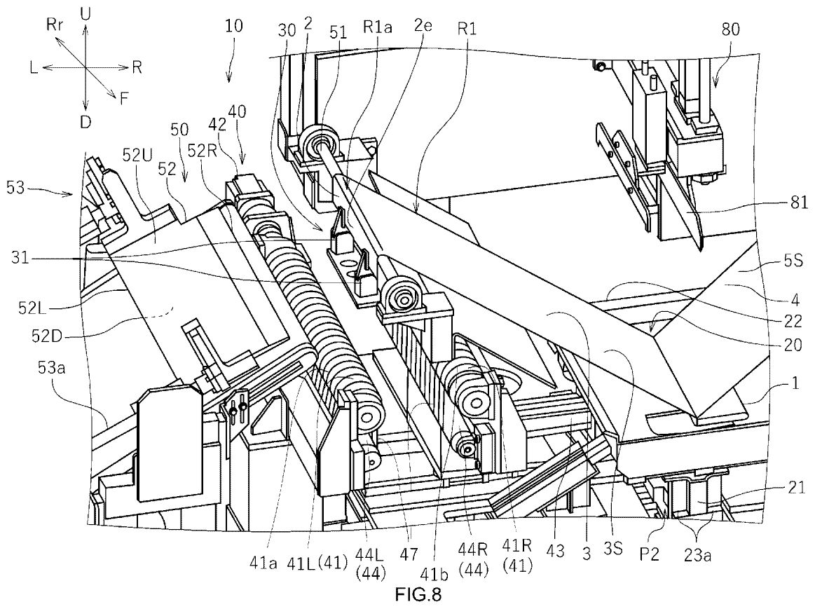

The air cylinder 24b is a cylinder that expands and contracts diagonally upward to the right and diagonally downward to the left, and moves the support member 24a toward or away from the rotation box 22. FIG. 7 is a partial cross-sectional view of the periphery of the electrode body accommodation part 20 when the air cylinder 24b is extended. When the air cylinder 24b extends diagonally upward to the right, the support member 24a is moved diagonally upward to the right. Accordingly, the support member 24a is disposed inside the through-hole 22h (refer to FIG. 5). In this case, the upper surface of the support member 24a is substantially flush with the bottom surface 22D of the rotation box 22. When the air cylinder 24b contracts diagonally downward to the left, the support member 24a moves away from the rotation box 22. After the holding jig 21 is moved below the rotation box 22 and before the electrode body 1 is unwound, the air cylinder 24b moves the support member 24a such that the upper surface of the support member 24a is substantially flush with the bottom surface 22D of the rotation box 22. Here, the direction in which the air cylinder 24b expands and contracts is not limited thereto. In addition, the actuator that moves the support member 24a is not limited to the air cylinder.

### Positive and Negative Electrode Separation Device

As shown in FIG. 4, the positive and negative electrode separation device 80 includes the center scraper 81 and a scraper lifting device 82. The center scraper 81 is a member that guides the negative electrode sheet 3 toward (that is, the left side) the first separator sheet 2 (refer to FIG. 7). The center scraper 81 is a plate-shaped member that extends in the front to rear direction and the up and down direction. The scraper lifting device 82 can lower the center scraper 81 such that the lower end of the center scraper 81 is disposed between the first outer end 2e and the second outer end 4e and raise the center scraper 81 such that the lower end of the center scraper 81 is removed from between the first outer end 2e and the second outer end 4e. As shown in FIG. 3, here, the scraper lifting device 82 includes an air cylinder 82a that expands and contracts in the up and down direction. FIG. 4 shows a state in which the center scraper 81 is lowered. As shown in FIG. 4, the center scraper 81 is lowered by the scraper lifting device 82, and inserted between the first outer end 2e and the second outer end 4e of the electrode body 1 before it is unwound. When the scraper lifting device 82 raises the center scraper 81, the center scraper 81 is positioned above the rotation box 22. However, the position of the center scraper 81 when the center scraper 81 is moved from the position between the first outer end 2e and the second outer end 4e is not limited thereto.

### First Gripping Unit

As shown in FIG. 4, the first gripping unit 30 includes a pair of first clamps 31 and a first movement device 32. The pair of first clamps 31 grip the first outer end 2e of the first separator sheet 2 (the negative electrode laminate sheet 3S). The pair of first clamps 31 are examples of the gripping member in the present invention. The pair of first clamps 31 include a front side clamp 31F and a rear side clamp 31Rr provided behind the front side clamp 31F. The front side clamp 31F grips the front side of the first outer end 2e. The rear side clamp 31Rr grips the rear side of the first outer end 2e. The first clamp 31 is disposed between the two first placement parts 21b arranged in the front to rear direction. Here, the number of first clamps 31 is not particularly limited.

The first movement device 32 moves the pair of first clamps 31 downstream from the pair of first nip rollers 41 (refer to FIG. 3) in the transfer direction of the first separator sheet 2 along the predetermined transfer path R1 (refer to FIG. 3) of the first separator sheet 2. Here, “moving along the transfer path R1 of the first separator sheet 2” is not limited to moving along a path that matches the transfer path R1 of the first separator sheet 2, but broadly means moving to pass through a predetermined side (between the pair of first nip rollers 41 or above the bending roller 51 in this case) of a member (for example, the pair of first nip rollers 41 of the first transfer unit 40, and a bending roller 51 of the first separation device 50 to be described below) disposed on the transfer path R1. The “transfer direction of the first separator sheet 2” is the direction along the transfer path R1. The transfer direction of the first separator sheet 2 changes depending on the position on the transfer path R1. Here, the path along which the first movement device 32 moves the pair of first clamps 31 extends along a path in the transfer path R1 until it passes between at least the pair of first nip rollers 41. Details of the path along which the first movement device 32 moves the pair of first clamps 31 will be described below. The first gripping unit 30 grips the first separator sheet 2 with the pair of first clamps 31, the first movement device 32 moves the pair of first clamps 31, and thus the first separator sheet 2 is pulled.

As shown in FIG. 4, the first movement device 32 includes a support unit 32a that supports the pair of first clamps 31, an up and down direction guide 32b that supports the support unit 32a such that it can move in the up and down direction, a left to right direction guide 32c (refer to FIG. 3) that supports the up and down direction guide 32b such that it can move in the left to right direction, an up and down direction movement motor 32d (refer to FIG. 3) that moves the support unit 32a along the up and down direction guide 32b, and a left to right direction movement motor 32e (refer to FIG. 3) that moves the up and down direction guide 32b along the left to right direction guide 32c.

As shown in FIG. 4, the support unit 32a extends in the front to rear direction. The support unit 32a includes a rotation device 32a1 that rotates the pair of first clamps 31 in the up and down direction. The rotation device 32a1 includes a rotation motor 32a2 having a rotation shaft that rotates about an axis A1 offset from the base ends (the left ends in this case) of the pair of first clamps 31 when viewed in the front to rear direction. The axis A1 of the rotation shaft of the rotation motor 32a2 extends in the front to rear direction. The pair of first clamps 31 rotate about the axis A1. The orientation of the pair of first clamps 31 can be changed by the rotation device 32a1.

As shown in FIG. 3, the up and down direction guide 32b extends in the up and down direction. When the up and down direction movement motor 32d is driven, the support unit 32a and the pair of first clamps 31 supported thereby are positioned along the up and down direction guide 32b in the up and down direction. The left to right direction guide 32c extends in the left to right direction. When the left to right direction movement motor 32e is driven, the up and down direction guide 32b, the support unit 32a, and the pair of first clamps 31 are positioned along the left to right direction guide 32c in the left to right direction. By combining the driving of the up and down direction movement motor 32d and the driving of the left to right direction movement motor 32e, the pair of first clamps 31 can be moved along a predetermined path when viewed in the front to rear direction.

### First Transfer Unit

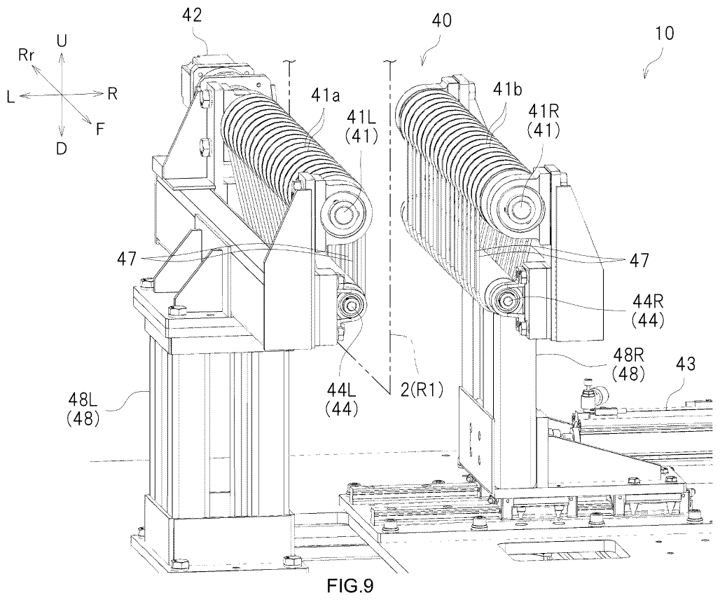

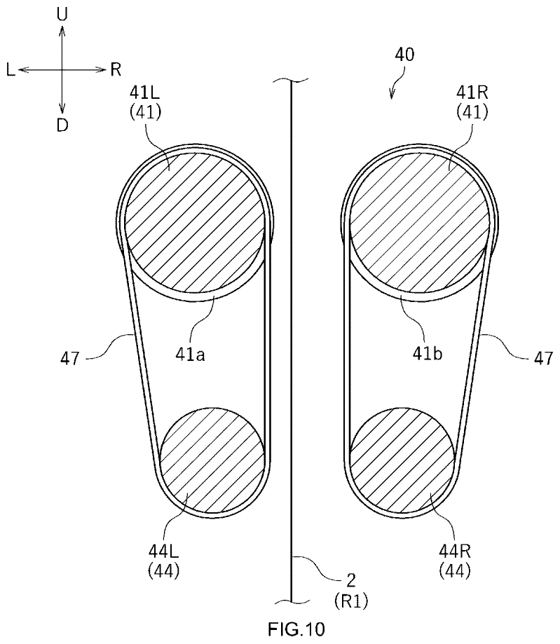

FIG. 9 is a perspective view of the first transfer unit 40. As shown in FIG. 9, the first transfer unit 40 includes the pair of first nip rollers 41 that rotate with the first separator sheet 2 interposed therebetween, a transfer motor 42 that rotates a first nip roller 41, a clamping cylinder 43 that moves the first nip roller 41 in the left to right direction, a pair of pulleys 44, and a pair of support units 48. The pair of first nip rollers 41 include a driving roller 41L and a driven roller 41R disposed to the right side of the driving roller 41L to face the driving roller 41L. Each of the pair of first nip rollers 41 includes a wire 47. The wire 47 is an example of a linear member (guide member) in the present invention. The pair of pulleys 44 include a pulley 44L and a pulley 44R disposed to face the pulley 44L. The pair of support units 48 include a support unit 48L that rotatably supports the driving roller 41L and the pulley 44L, and a support unit 48R that rotatably supports the driven roller 41R and the pulley 44R. The wire 47 is wound around the driving roller 41L and the pulley 44L, and the driven roller 41R and the pulley 44R.

The driving roller 41L and the driven roller 41R are positioned below the bending roller 51 (refer to FIG. 8) to be described below. The material forming the driving roller 41L and the driven roller 41R is not particularly limited. For example, the driving roller 41L and the driven roller 41R are metal rollers. The length of the driving roller 41L and the driven roller 41R in the front to rear direction is longer than the length of the electrode body 1 in the front to rear direction.

A plurality of grooves 41a and 41b are formed in the circumferential direction in the driving roller 41L and the driven roller 41R. The grooves 41a are formed along the entire outer circumferential surface of the driving roller 41L. The grooves 41b are formed along the entire outer circumferential surface of the driven roller 41R. A part of the wire 47 is wound around the grooves 41a and 41b. The grooves 41a and 41b prevent the wire 47 from shifting in the front to rear direction. The depth (the length of the first nip roller 41 in the radial direction) of the grooves 41a and 41b is not particularly limited, but here, the depth of the grooves 41a and 41b is formed to be substantially the same as the wire diameter of the wire 47 or to be slightly deeper than the wire diameter of the wire 47. Here, the depth of the grooves 41a and 41b is formed slightly deeper than the wire diameter of the wire 47. A plurality of grooves 41a and 41b are formed at equal intervals in the front to rear direction. However, the number of grooves 41a and 41b is not particularly limited. In addition, the intervals between the grooves 41a and the intervals between the grooves 41b are not limited to equal intervals.

The transfer motor 42 rotates the first nip roller 41, and transfers the first separator sheet 2. The transfer motor 42 is an example of a drive device in the present invention. The transfer motor 42 is connected to the driving roller 41L, and when the transfer motor 42 is driven, the driving roller 41L rotates. The clamping cylinder 43 is an air cylinder that expands and contracts in the left to right direction. The clamping cylinder 43 is connected to the support unit 48R. When the clamping cylinder 43 extends to the left side, the support unit 48R moves to the left side. In this case, the driven roller 41R and the pulley 44R supported by the support unit 48R move to the left side, and the first separator sheet 2 (refer to FIG. 3) is interposed between the driving roller 41L and the driven roller 41R. When the clamping cylinder 43 contracts to the right side, the support unit 48R moves to the right side. In this case, the driven roller 41R and the pulley 44R supported by the support unit 48R move to the right side. However, the actuator that moves the driven roller 41R and the pulley 44R in the left to right direction is not limited to the air cylinder, and may be, for example, a motor.

The pulley 44L is disposed below the driving roller 41L. The pulley 44R is disposed below the driven roller 41R. The pulley 44 is positioned downstream from the first nip roller 41 in the transfer direction of the first separator sheet 2. Here, the positions of the pulley 44L and the pulley 44R in the up and down direction are aligned. The wire 47 is wound around each of the pulley 44L and the pulley 44R. When the driving roller 41L rotates, the wire 47 travels, and the pulley 44L rotates. When the driven roller 41R rotates, the wire 47 travels, and the pulley 44R rotates.

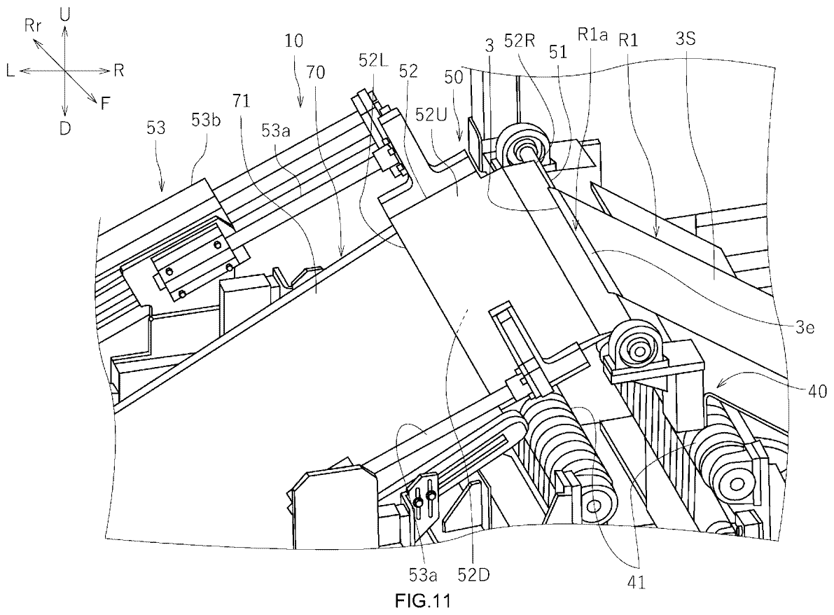

The wire 47 is wound around the first nip roller 41 and the pulley 44. More specifically, the wire 47 is wound around the groove 41a of the driving roller 41L and the pulley 44L, and the groove 41b of the driven roller 41R and the pulley 44R. FIG. 10 is a cross-sectional view of the first nip roller 41 and the pulley 44. The right portion of the wire 47 wound around the driving roller 41L and the pulley 44L is wound such that it extends in a substantially vertical direction. Here, the substantially vertical direction is the tangential direction of the driving roller 41L, and the transfer direction of the first separator sheet 2 when the first separator sheet 2 is transferred by the first transfer unit 40. The position of the pulley 44L in the left to right direction is determined such that the wire 47 extends in the tangential direction and in the substantially vertical direction. Similarly, the wire 47 is wound around the driven roller 41R and the pulley 44R such that the left portion of the wire 47 extends in the substantially vertical direction. The substantially vertical direction is the tangential direction of the driven roller 41R and the transfer direction of the first separator sheet 2 when the first separator sheet 2 is transferred by the first transfer unit 40.

FIG. 12 is a front view of the first transfer unit 40 when the first separator sheet 2 is interposed between the first nip rollers 41. The first transfer unit 40 drives the clamping cylinder 43 (refer to FIG. 9) in a state where the first separator sheet 2 is located between the driving roller 41L and the driven roller 41R and nips the first separator sheet 2 with the driving roller 41L and the driven roller 41R. When the transfer motor 42 (refer to FIG. 9) is driven, the driving roller 41L rotates such that the side facing the driven roller 41R moves downward, and transfers the first separator sheet 2 downward together with the driven roller 41R. In this case, the wire 47 wound around the driving roller 41L and the pulley 44L and the wire 47 wound around the driven roller 41R and the pulley 44R travel. The first separator sheet 2 moves along the wire 47 on the predetermined transfer path R1. As shown in FIG. 3, the first separator collection unit 60 is provided below the driving roller 41L and the driven roller 41R.

### First Separation Device

The first separation device 50 separates the first separator sheet 2 and the negative electrode sheet 3 (refer to FIG. 1) at a position upstream from the first transfer unit 40 on the transfer path R1 of the first separator sheet 2. FIG. 8 is a perspective view of the first separation device 50. As shown in FIG. 8, the first separation device 50 includes the bending roller 51, a scraper 52, and a scraper insertion device 53.

The bending roller 51 is provided on the transfer path R1 of the first separator sheet 2 and bends the transfer path R1. The bending roller 51 extends in the front to rear direction. The bending roller 51 is configured to be rotatable about the rotation shaft that extends in the front to rear direction. In the present embodiment, the bending roller 51 is provided on the left side of and above the rotation box 22 of the electrode body accommodation part 20. The first separator sheet 2 is wound around the bending roller 51 from above by the first gripping unit 30. Between the electrode body accommodation part 20 and the bending roller 51, the first separator sheet 2 is transferred diagonally upward to the left.

The bending roller 51 is provided above the pair of first nip rollers 41 of the first transfer unit 40. The bending roller 51 bends the transfer path R1 of the first separator sheet 2 toward the pair of first nip rollers 41 (downward in this case). However, the direction in which the bending roller 51 bends the transfer path R1 of the first separator sheet 2 is not particularly limited. The direction in which the bending roller 51 bends the transfer path R1 of the first separator sheet 2 may be, for example, upward. The angle at which the bending roller 51 bends the transfer path R1 is not particularly limited.

The scraper 52 is a member that peels the negative electrode sheet 3 off from the first separator sheet 2. The scraper 52 is formed in a plate shape that extends in the front to rear direction and the left to right direction, and includes an upper surface 52U and a lower surface 52D. The scraper 52 separates the first separator sheet 2 and the negative electrode sheet 3 on the side of the upper surface 52U and the side of the lower surface 52D. A tip part 52R of the scraper 52 has a tapered shape in a front view such that its height in the up and down direction decreases toward the upstream side of the transfer path R1 of the first separator sheet 2. In the present embodiment, the upper surface 52U of the scraper 52 is bent to form a tapered shape of the tip part 52R. Here, the lower surface 52D of the scraper 52 is flat. The width of the scraper 52 in the front to rear direction is longer than the width of the negative electrode sheet 3.

The scraper insertion device 53 inserts the scraper 52 into a bent portion R1a of the transfer path R1 or retracts it from the bent portion R1a. FIG. 11 is a perspective view of the first separation device 50 in a state where the scraper 52 is inserted into the bent portion R1a of the transfer path R1. As shown in FIG. 11, the scraper 52 is disposed at the bent portion R1a of the transfer path R1 of the first separator sheet 2 at the right side end position. The scraper insertion device 53 inserts the scraper 52 into the transfer path R1 after the first outer end 2e of the first separator sheet 2 (refer to FIG. 1) passes through the bent portion R1a and before the outer end 3e of the negative electrode sheet 3 reaches the bent portion R1a. When the scraper 52 is inserted into the transfer path R1 at this timing, the first separator sheet 2 can be wound around the bending roller 51, and the tip part 52R of the scraper 52 enters between the first separator sheet 2 and the negative electrode sheet 3 by the subsequent movement of the first separator sheet 2. When the negative electrode sheet 3 is peeled off from the first separator sheet 2 by the scraper 52, the negative electrode sheet 3 above the first separator sheet 2 rests on the upper surface 52U of the scraper 52. The first separator sheet 2 below the negative electrode sheet 3 is transferred along the side of the lower surface 52D of the scraper 52.

As shown in FIG. 11, the scraper insertion device 53 includes a pair of front and rear guide rods 53a and an insertion cylinder 53b. When the insertion cylinder 53b is driven, the scraper 52 moves along the guide rod 53a toward or away from the bending roller 51. In the present embodiment, the scraper insertion device 53 supports the scraper 52 obliquely such that the tip part 52R of the scraper 52 is positioned higher than a base end 52L. The scraper 52 is inclined upward toward the right side. The scraper insertion device 53 moves the scraper 52 diagonally upward to the right, and causes it approach the bending roller 51. When the scraper insertion device 53 is driven toward the scraper 52, the scraper 52 comes into contact with the surface of the first separator sheet 2 wound around the bending roller 51 (comes into contact with the bending roller 51 with the first separator sheet 2 therebetween).

As shown in FIG. 3, the negative electrode sheet collection unit 70 is disposed below the scraper 52, and includes a guide plate 71 that extends to the left side of the scraper 52, and a negative electrode sheet collection box 72 disposed below the left end of the guide plate 71. The negative electrode sheet 3 separated by the first separation device 50 and placed on the upper surface 52U of the scraper 52 (refer to FIG. 11) is transported onto the guide plate 71 as the first separator sheet 2 is transferred by the first transfer unit 40. The guide plate 71 is inclined downward to the left. The negative electrode sheet 3 that has passed over the guide plate 71 is accommodated in the negative electrode sheet collection box 72 shown in FIG. 3.

### Second Gripping Unit

The second gripping unit 130 shown in FIG. 4 has the same configuration as the first gripping unit 30 that grips the first separator sheet 2. The second gripping unit 130 includes a pair of second clamps 131 and a second movement device 132. The pair of second clamps 131 grip the second outer end 4e of the second separator sheet 4 (the positive electrode laminate sheet 5S). The pair of second clamps 131 are examples of the gripping member in the present invention. The pair of second clamps 131 include a front side clamp 131F and a rear side clamp 131Rr provided behind the front side clamp 131F. The front side clamp 131F grips the front side of the second outer end 4e. The rear side clamp 131Rr grips the rear side of the second outer end 4e. The second clamp 131 is disposed between the two second placement parts 21c arranged in the front to rear direction. Here, the number of second clamps 131 is not particularly limited.

The second movement device 132 moves the pair of second clamps 131 downstream from a pair of second nip rollers 141 in the transfer direction of the second separator sheet 4 along a predetermined transfer path R2 (refer to FIG. 3) of the second separator sheet 4. The meaning of “along the transfer path R2” is the same as in the case of the transfer path R1 (refer to FIG. 3) of the first separator sheet 2. The “transfer direction of the second separator sheet 4” is the direction along the transfer path R2. The transfer direction of the second separator sheet 4 changes depending on the position on the transfer path R2. The second movement device 132 includes a support unit 132a including a rotation device 132a1 that rotates the pair of second clamps 131, an up and down direction guide 132b that supports the support unit 132a such that it can move in the up and down direction, a left to right direction guide 132c (refer to FIG. 3) that supports the up and down direction guide 132b such that it can move in the left to right direction, an up and down direction movement motor 132d (refer to FIG. 3) that moves the support unit 132a along the up and down direction guide 132b, and a left to right direction movement motor 132e (refer to FIG. 3) that moves the up and down direction guide 132b along the left to right direction guide 132c. The rotation device 132a1 includes a rotation motor 132a2 having a rotation shaft that rotates about an axis A2 offset from the base ends (the right ends in this case) of the pair of second clamps 131 when viewed in the front to rear direction. The orientation of the pair of second clamps 131 can be changed by the rotation device 132a1. The second gripping unit 130 grips the second separator sheet 4 with the pair of second clamps 131, the second movement device 132 moves the pair of second clamps 131, and thus the second separator sheet 4 is pulled.

### Second Transfer Unit

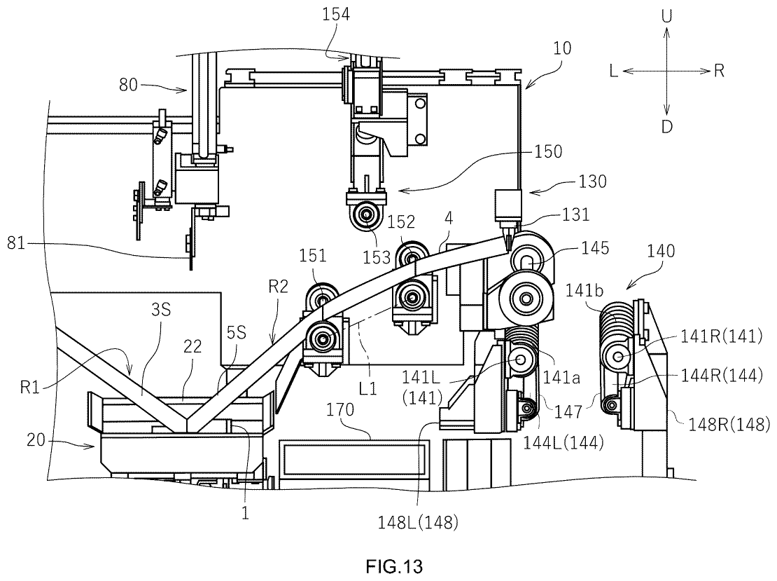

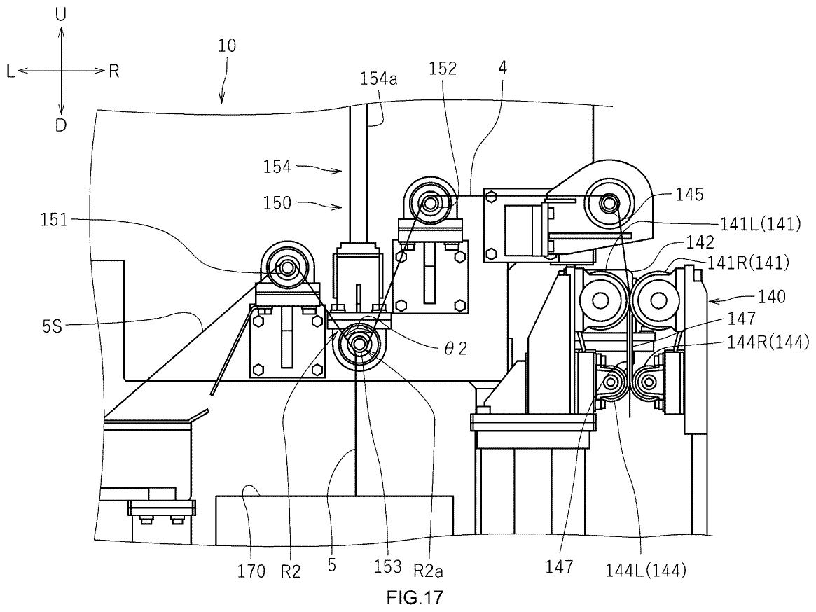

FIG. 13 is a perspective view of the second transfer unit 140 and the second separation device 150. As shown in FIG. 13, the second transfer unit 140 that transfers the second separator sheet 4 has the same configuration as the first transfer unit 40 that transfers the first separator sheet 2 (refer to FIG. 9). The second transfer unit 140 includes the pair of second nip rollers 141 that rotate with the second separator sheet 4 interposed therebetween, a transfer motor 142 (refer to FIG. 17) that rotates the second nip roller 141, a clamping cylinder 143 (refer to FIG. 2) that moves the second nip roller 141 in the left to right direction, a pair of pulleys 144, a bending roller 145, and a pair of support units 148. The pair of second nip rollers 141 include a driving roller 141L and a driven roller 141R disposed to the right side of the driving roller 141L to face the driving roller 141L. Each of the pair of second nip rollers 141 includes a wire 147. The pair of pulleys 144 include a pulley 144L positioned below the driving roller 141L and a pulley 144R positioned below the driven roller 141R. The pair of support units 148 include a support unit 148L that rotatably supports the driving roller 141L and the pulley 144L, and a support unit 148R that rotatably supports the driven roller 141R and the pulley 144R. The wire 147 is wound around the driving roller 141L and the pulley 144L, and the driven roller 141R and the pulley 144R. Above the driving roller 141L and the driven roller 141R, the bending roller 145 that bends the transfer path R2 of the second separator sheet 4, which has been substantially horizontal up to that point, in the substantially vertical direction, and guides it toward the driving roller 141L and the driven roller 141R is provided.

The driving roller 141L and the driven roller 141R are positioned below the bending roller 145. The material forming the driving roller 141L and the driven roller 141R is not particularly limited. For example, the driving roller 141L and the driven roller 141R are metal rollers. The length of the driving roller 141L and the driven roller 141R in the front to rear direction is longer than the length of the electrode body 1 in the front to rear direction.

Similar to the driving roller 41L (refer to FIG. 9) and the driven roller 41R (refer to FIG. 9) of the first transfer unit 40 (refer to FIG. 9), grooves 141a and 141b are formed in the driving roller 141L and the driven roller 141R. The wire 147 is wound around each of the grooves 141a and 141b. The transfer motor 142 rotates the second nip roller 141, and transfers the second separator sheet 4. The transfer motor 142 is an example of a drive device in the present invention. The transfer motor 142 is connected to the driving roller 141L. The pulley 144 is positioned below the second nip roller 141 (downstream from the second nip roller 141 in the transfer direction of the second separator sheet 4).

The wire 147 is wound around the second nip roller 141 and the pulley 144. More specifically, the wire 147 is wound around the groove 141a of the driving roller 141L and the pulley 144L, and the groove 141b of the driven roller 141R and the pulley 144R. The wire 147 is wound such that it extends in the substantially vertical direction. Here, the substantially vertical direction is the tangential direction of the driving roller 141L, and the transfer direction of the second separator sheet 4 when the second separator sheet 4 is transferred by the second transfer unit 140.

The second transfer unit 140 drives the clamping cylinder 143 in a state where the second separator sheet 4 is located between the driving roller 141L and the driven roller 141R, and nips the second separator sheet 4 between the driving roller 141L and the driven roller 141R (refer to FIG. 17). When the transfer motor 142 (refer to FIG. 17) is driven, the driving roller 141L rotates such that the side facing the driven roller 141R moves downward, and transfers the second separator sheet 4 downward together with the driven roller 141R. In this case, the wire 147 wound around the driving roller 141L and the pulley 144L travels. The second separator sheet 4 moves on the predetermined transfer path R2 along the wire 147. The second separator collection unit 160 (refer to FIG. 1) is provided below the driving roller 141L and the driven roller 141R.

### Second Separation Device

As shown in FIG. 13, the second separation device 150 separates the second separator sheet 4 and the positive electrode sheet 5 at a position upstream from the second transfer unit 140 on the transfer path R2 of the second separator sheet 4. Here, FIG. 13 is a diagram showing a state in which the second separator sheet 4 is being wound around the second separation device 150. As shown in FIG. 13, the second separation device 150 includes an upstream roller 151, a downstream roller 152, a peeling roller 153, and a roller lowering device 154.

The upstream roller 151 is provided on the transfer path R2 of the second separator sheet 4, and the second separator sheet 4 (the positive electrode laminate sheet 5S) is wound therearound. The upstream roller 151 extends in the front to rear direction. The upstream roller 151 is configured to be rotatable about the rotation shaft that extends in the front to rear direction. In the present embodiment, the upstream roller 151 is provided on the right side of and above the rotation box 22 of the electrode body accommodation part 20. The second separator sheet 4 (the positive electrode laminate sheet 5S) is wound around the upstream roller 151 from above by the second gripping unit 130. Between the electrode body accommodation part 20 and the upstream roller 151, the second separator sheet 4 (the positive electrode laminate sheet 5S) is transferred diagonally upward to the right.

The downstream roller 152 is provided downstream from the upstream roller 151 on the transfer path R2 of the second separator sheet 4, and the second separator sheet 4 is wound therearound. Here, the downstream roller 152 is provided on the right side of and above the upstream roller 151. The downstream roller 152 extends in the front to rear direction. The downstream roller 152 is configured to be rotatable about the rotation shaft that extends in the front to rear direction. The second separator sheet 4 is wound around the upstream roller 151 from above by the second gripping unit 130. The downstream roller 152 is provided at substantially the same height as the bending roller 145 of the second transfer unit 140. Between the downstream roller 152 and the bending roller 145, the second separator sheet 4 is transferred substantially horizontally.

The peeling roller 153 is disposed between the upstream roller 151 and the downstream roller 152 in the left to right direction. The peeling roller 153 is a roller that is provided on the transfer path R2 of the second separator sheet 4, bends the transfer path R2, and separates the second separator sheet 4 and the positive electrode sheet 5. The peeling roller 153 extends in the front to rear direction. The peeling roller 153 rotates about the rotation shaft that extends in the front to rear direction.

The roller lowering device 154 can lower the peeling roller 153 and move it below a line L1 connecting the upstream roller 151 and the downstream roller 152. Here, the roller lowering device 154 moves the peeling roller 153 downward and causes it to collide with the second separator sheet 4. In addition, the roller lowering device 154 can raise the peeling roller 153 and move it above the line L1 connecting the upstream roller 151 and the downstream roller 152. As shown in FIG. 3, the roller lowering device 154 includes an air cylinder 154a that expands and contracts in the up and down direction. However, the configuration of the roller lowering device 154 is not limited thereto. For example, the roller lowering device 154 may include a motor for raising and lowering the peeling roller 153.

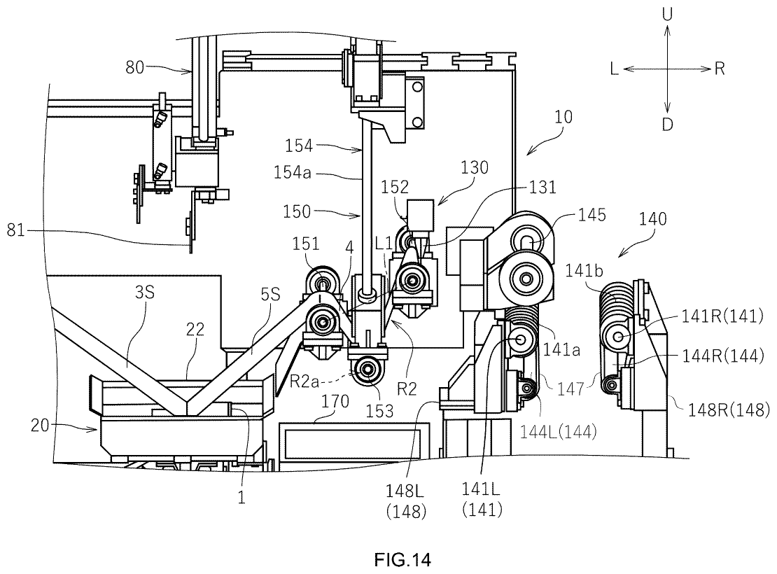

FIG. 14 is a perspective view of the second separation device 150 in a state where the peeling roller 153 is lowered. As shown in FIG. 14, when the roller lowering device 154 is driven to lower the peeling roller 153 below the line L1 in a state where the positive electrode laminate sheet 5S is wound around the upstream roller 151 and the downstream roller 152, the transfer path R2 is bent into a V-shape by the peeling roller 153. When the transfer path R2 is bent into a V-shape, the positive electrode sheet 5 is separated from the second separator sheet 4. The positive electrode sheet collection unit 170 that collects the positive electrode sheet 5 is provided below the peeling roller 153. The angle at which the transfer path R2 is bent by the peeling roller 153 is not particularly limited.

Here, the upstream roller 151 and the downstream roller 152 may be arranged in a direction other than the left to right direction, for example, the up and down direction. The movement direction of the peeling roller 153 is not particularly limited as long as it is a direction that intersects a line connecting the upstream roller 151 and the downstream roller 152.

As shown in FIG. 12, the static eliminator 90 is disposed below the first separation device 50. The static eliminator 90 is provided downstream from the scraper 52 in the transfer direction of the first separator sheet 2. The static eliminator 90 is a device that eliminates static electricity from the first separator sheet 2 from which the negative electrode sheet 3 has been peeled off. The static eliminator 90 includes an ionizer (not shown). The ionizer is a device that generates ions. The method of generating ions is not particularly limited, and various known methods can be applied, and for example, a method of generating ions using corona discharge may be used. In this case, the ionizer includes a plurality of needle-shaped electrodes. Corona discharge is a phenomenon in which discharge occurs at the tip of a needle-shaped electrode when a high voltage is applied to the electrode. Due to this discharge, air around the electrode is ionized. For example, the static eliminator 90 includes a blowing unit (not shown) that blows air. Air ionized by the ionizer is blown by the blowing unit. The static eliminator 90 sends the ionized air to the first separator sheet 2 from which the negative electrode sheet 3 has been peeled off. Here, the position of the static eliminator 90 is not limited to being below the first separation device 50. The static eliminator 90 may be provided at any position as long as it can send the ionized air to the first separator sheet 2 from which the negative electrode sheet 3 has been peeled off by the scraper 52. Here, the static eliminator 90 is not limited to one having an ionizer as long as it can eliminate static electricity from the first separator sheet 2.

### Control Device

The control device 100 shown in FIG. 3 is connected to the air cylinder 23b of the jig lowering device 23, the air cylinder 24b of the electrode body support device 24 (refer to FIG. 6), the pair of first clamps 31 of the first gripping unit 30, the rotation motor 32a2 (refer to FIG. 4), the up and down direction movement motor 32d, the left to right direction movement motor 32e, the transfer motor 42 and the clamping cylinder 43 of the first transfer unit 40 (refer to FIG. 8), the insertion cylinder 53b of the scraper insertion device 53 (refer to FIG. 8), the pair of second clamps 131 of the second gripping unit 130, the rotation motor 132a2 (refer to FIG. 4), the up and down direction movement motor 132d, the left to right direction movement motor 132e, the transfer motor 142 of the second transfer unit 140 (refer to FIG. 17), the clamping cylinder 143, the air cylinder 154a of the roller lowering device 154, the air cylinder 82a of the scraper lifting device 82, and the static eliminator 90 (refer to FIG. 12), and controls operations of these components. The control device 100 controls respective components, and causes them to perform operations described below in the process of disassembling the electrode body 1.

The configuration of the control device 100 is not particularly limited. The control device 100 may include, for example, a microcomputer. The microcomputer may include, for example, an interface (I/F) that receives data and the like from external devices, a central processing unit (CPU) that executes program instructions, a read only memory (ROM) that stores the program executed by the CPU, a random access memory (RAM) used as a working area that opens the program, and a storage device such as a memory that stores the program and various types of data. The control device 100 may include, for example, a programmable controller.

### Electrode Body Disassembly Process

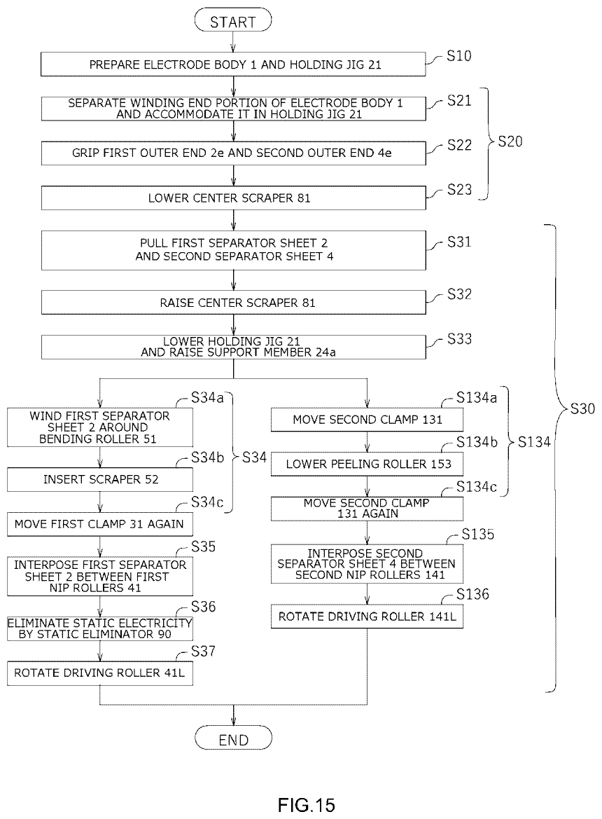

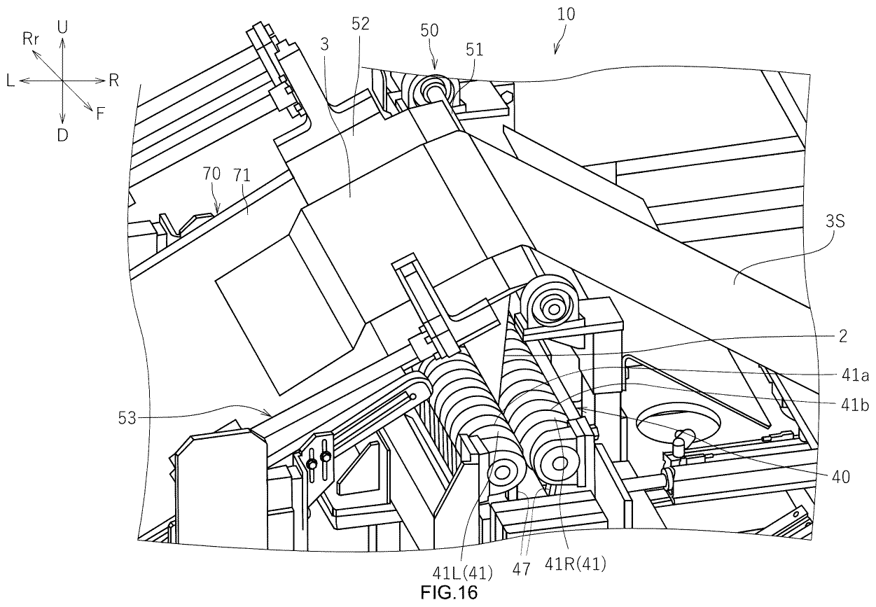

Hereinafter, an example of a process of disassembling the electrode body 1 using the electrode body disassembly device 10 according to the present embodiment will be described. FIG. 15 is a flowchart showing the process of disassembling the electrode body 1.

### Separation of Negative Electrode and Positive Electrode

A preparation step S10 shown in FIG. 15 is a step of preparing the strip-shaped first separator sheet 2, the strip-shaped second separator sheet 4, the strip-shaped negative electrode sheet 3, and the strip-shaped positive electrode sheet 5. Here, the wound electrode body 1 in which the first separator sheet 2, the second separator sheet 4, the negative electrode sheet 3, and the positive electrode sheet 5 are laminated and wound in a predetermined winding direction is prepared.

Here, the electrode body 1 is removed from the used electricity storage device 200 (refer to FIG. 1), and the electrode body 1 is prepared. For example, the case 210 of the electricity storage device 200 is cut along a cutting line F shown in FIG. 1, and the electrode body 1 is removed from the inside of the case 210. In addition, in the preparation step S10 shown in FIG. 15, the holding jig 21 is also prepared. A separation preparation step S20 is a step of preparing separation of the electrode body 1 into the first separator sheet 2, the negative electrode sheet 3, the second separator sheet 4 and the positive electrode sheet 5. As shown in FIG. 15, the separation preparation step S20 includes an electrode body accommodation step S21, a gripping step S22, and a scraper lowering step S23.

The electrode body accommodation step S21 is a step of accommodating the electrode body 1 in the holding jig 21. In the electrode body accommodation step S21, the winding end portion of the electrode body 1 is peeled off, the first outer end 2e of the first separator sheet 2 is folded to the left side, and the second outer end 4e of the second separator sheet 4 is folded to the right side. Then, the both ends (the front end and the rear end in this case) of the first outer end 2e of the first separator sheet 2 are placed on the first placement part 21b of the holding jig 21, and the both ends (the front end and the rear end in this case) of the second outer end 4e of the second separator sheet 4 in the width direction are placed on the second placement part 21c of the holding jig 21 (refer to FIG. 4). The electrode body accommodation step S21 may be performed manually. However, the electrode body accommodation step S21 may be performed by an automatic device or a semi-automatic device.

The gripping step S22 is a step of gripping the first outer end 2e of the first separator sheet 2 with the pair of first clamps 31 of the first gripping unit 30 and gripping the second outer end 4e of the second separator sheet 4 with the pair of second clamps 131 of the second gripping unit 130 (refer to FIG. 4).

The scraper lowering step S23 is a step of disposing the center scraper 81 that guides the negative electrode sheet 3 between the first outer end 2e and the second outer end 4e. In the scraper lowering step S23, the center scraper 81 is lowered by the scraper lifting device 82, and inserted between the negative electrode laminate sheet 3S and the positive electrode laminate sheet 5S (refer to FIG. 4). When the center scraper 81 is lowered, the center scraper 81 is disposed between the first outer end 2e of the first separator sheet 2 and the second outer end 4e of the second separator sheet 4. Here, the scraper lowering step S23 may be performed before the timing shown in FIG. 15 as long as it is performed before a pulling step S31 to be described below.

A separation step S30 is a step of pulling the first separator sheet 2 and the second separator sheet 4 and drawing out and separating the first separator sheet 2, the second separator sheet 4, the negative electrode sheet 3 and the positive electrode sheet 5. The separation step S30 includes the pulling step S31, a center scraper raising step S32, an electrode body removal step S33, a negative electrode separation step S34, a first separator interposing step S35, a static elimination step S36, a first separator transfer step S37, a positive electrode separation step S134, a second separator interposing step S135, and a second separator transfer step S136.

The pulling step S31 is a step of pulling the first separator sheet 2 gripped by the pair of first clamps 31 diagonally upward to the left by the first movement device 32 and pulling the second separator sheet 4 gripped by the pair of second clamps 131 diagonally upward to the right by the second movement device 132 (refer to FIG. 7). As shown in FIG. 7, when the first separator sheet 2 and the second separator sheet 4 are pulled, the pair of first clamps 31 are rotated clockwise in a front view, and the pair of first clamps 31 are oriented such that their tip parts face diagonally downward to the right. In addition, when the first separator sheet 2 and the second separator sheet 4 are pulled, the pair of second clamps 131 are rotated 45 degrees counterclockwise, and the pair of second clamps 131 are oriented such that their tip parts face diagonally downward to the left. When the first separator sheet 2 and the second separator sheet 4 are pulled, the outer end 3e of the negative electrode sheet 3 is exposed between the first separator sheet 2 and the second separator sheet 4.

The center scraper raising step S32 shown in FIG. 15 is a step of moving the center scraper 81 to a position where it does not come into contact with the electrode body 1 after the pulling step S31. In the center scraper raising step S32, the scraper lifting device 82 raises the center scraper 81 to a position above the rotation box 22.

The electrode body removal step S33 is a step of removing the electrode body 1 accommodated in the holding jig 21. In the electrode body removal step S33, when the air cylinder 23b of the jig lowering device 23 (refer to FIG. 3) contracts, the positioning member 23a (refer to FIG. 4) moves downward. The holding jig 21 is lowered from the accommodation position P1 (refer to FIG. 4) to the separation position P2 (refer to FIG. 8). Therefore, the holding jig 21 passes through the through-hole 22h of the rotation box 22 in the up and down direction and descends. In this case, the electrode body 1 is placed on the bottom surface 22D of the rotation box 22. In this case, the electrode body 1 is removed from the holding part 21a (refer to FIG. 7). After the holding part 21a moves to the separation position P2, the support member 24a positioned below the rotation box 22 is moved diagonally upward to the right by the air cylinder 24b. Accordingly, the support member 24a is disposed inside the through-hole 22h of the rotation box 22, and the upper surface of the support member 24a is substantially flush with the bottom surface 22D (refer to FIG. 7). Accordingly, the electrode body 1 can rotate freely.

### Collection of First Separator Sheet and Negative Electrode Sheet

The negative electrode separation step S34 is a step of winding the negative electrode laminate sheet 3S around the bending roller 51, bending the transfer path R1 of the first separator sheet 2, inserting the plate-shaped scraper 52 into the bent portion R1a of the transfer path R1, and separating the first separator sheet 2 and the negative electrode sheet 3 on the sides of the lower surface 52D and the upper surface 52U of the scraper 52 (refer also to FIG. 8). The negative electrode separation step S34 includes a winding step S34a, a scraper insertion step S34b, and a clamp re-moving step S34c.

The winding step S34a is a step of moving the pair of first clamps 31 above and to the left side of the bending roller 51, additionally moving them from there to below and to the left side of the bending roller 51, and winding the first separator sheet 2 around the bending roller 51 (refer to FIG. 8). In this case, in the front to rear direction, the first clamp 31 is positioned further inside than the front end and the rear end of the wire 47 (refer to FIG. 8). Here, the “front end of the wire 47” refers to the front end of the wire 47 positioned foremost among the plurality of wires 47 arranged in the front to rear direction. The “rear end of the wire 47” refers to the rear end of the wire 47 positioned rearmost among the plurality of wires 47 arranged in the front to rear direction. When the first separator sheet 2 is wound around the bending roller 51, the movement of the pair of first clamps 31 is stopped. In this case, the negative electrode sheet 3 is positioned upstream from the bending roller 51 on the transfer path R1.

The scraper insertion step S34b is a step of moving the scraper 52 to the right side and inserting it into the bent portion R1a of the transfer path R1 after the first outer end 2e of the first separator sheet 2 passes through the bent portion R1a of the transfer path R1 and before the outer end 3e of the negative electrode sheet 3 reaches the bent portion R1a of the transfer path R1 (refer to FIG. 11).

The clamp re-moving step S34c is a step of transferring the negative electrode sheet 3 and the first separator sheet 2 along the transfer path R1 and peeling the negative electrode sheet 3 off from the first separator sheet 2. In the clamp re-moving step S34c, the pair of first clamps 31 are moved downward. Therefore, the negative electrode sheet 3 is moved to a position of the tip part 52R of the scraper 52 (refer to FIG. 11). As the first separator sheet 2 is sent downstream on the transfer path R1, the negative electrode sheet 3 is sequentially peeled off from the first separator sheet 2 by the scraper 52. The same applies after the device that transfers the first separator sheet 2 is changed to the first transfer unit 40. In the clamp removing step S34c, the tip part 52R of the scraper 52 is inserted between the first separator sheet 2 and the turned-up negative electrode sheet 3.

The first separator interposing step S35 is a step of moving the first separator sheet 2 downstream from the pair of first nip rollers 41 in the transfer direction of the first separator sheet 2 along the transfer path R1 and interposing the first separator sheet 2 between the first nip rollers 41. As shown in FIG. 12, the pair of first clamps 31 are moved by the first movement device 32 (refer to FIG. 4). Here, the pair of first clamps 31 pass between the pair of first nip rollers 41, and are moved below the pair of pulleys 44. In a winding step S31a (refer to FIG. 15), the first clamp 31 is positioned further inside than the front end and the rear end of the wire 47. Therefore, in the first separator interposing step S35, the first clamp 31 is positioned further inside the front end and the rear end of the wire 47 (refer also to FIG. 8). When the first separator sheet 2 is introduced between the pair of first nip rollers 41, the clamping cylinder 43 (refer to FIG. 9) is driven, the driven roller 41R is moved to the left side, and the first separator sheet 2 is interposed between the driving roller 41L and the driven roller 41R. When the first separator sheet 2 is interposed, the gripping of the first clamp 31 is released.

The static elimination step S36 is a step of eliminating static electricity from the first separator sheet 2 from which the negative electrode sheet 3 has been peeled off. In the static elimination step S36, the static eliminator 90 sends the ionized air to the first separator sheet 2. Accordingly, the static electricity of the first separator sheet 2 is eliminated. Here, the static eliminator 90 may send the ionized air before the static elimination step S36. When the first separator sheet 2 from which the negative electrode sheet 3 has been peeled off is transferred below the scraper 52, the ionized air hits the first separator sheet 2 and static electricity is eliminated.

The first separator transfer step S37 shown in FIG. 15 is a step of rotating the driving roller 41L (that is, rotating the pair of first nip rollers 41) and transferring and drawing out the first separator sheet 2. FIG. 16 is a perspective view of the first transfer unit 40 and the first separation device 50 while transferring the first separator sheet 2. As shown in FIG. 16, when the first separator sheet 2 is transferred by the first transfer unit 40, the first separator sheet 2 and the negative electrode sheet 3 are unwound from the electrode body 1, and the first separator sheet 2 and the negative electrode sheet 3 are separated and collected. The transfer motor 42 (refer to FIG. 9) rotates the driving roller 41L such that the side facing the driven roller 41R moves downward, and transfers the first separator sheet 2 in the substantially vertical direction together with the driven roller 41R. Therefore, the first separator sheet 2 is transferred in the substantially vertical direction along the wire 47 that extends in the substantially vertical direction (the tangential direction of the driving roller 41L and the driven roller 41R and the transfer direction of the first separator sheet 2). Since the first separator collection unit 60 (refer to FIG. 12) is disposed below the driving roller 41L and the driven roller 41R, the transferred first separator sheet 2 is collected in the first separator collection unit 60.

Here, although not shown in FIG. 15, during the movement of the pair of first clamps 31, the orientation of the pair of first clamps 31 is changed appropriately by the rotation device 32a1. Specifically, in the gripping step S22, the pair of first clamps 31 are oriented such that their tip parts face the right side (refer to FIG. 4). As described above, in the pulling step S31, the first clamps 31 are rotated such that their tip parts face diagonally downward to the right. In the negative electrode separation step S34, the pair of first clamps 31 are rotated counterclockwise in a front view and oriented such that their tip parts face upward (refer to FIG. 7). Therefore, the first separator sheet 2 can be smoothly pulled and transferred to the first transfer unit 40. However, the orientation of the pair of first clamps 31 is not limited to the above orientation. Unless a particular problem occurs, the pair of first clamps 31 may be simply supported by the support unit 32a in a swingable manner or may be fixed to the support unit 32a in a non-swingable manner.

### Collection of Second Separator Sheet and Positive Electrode Sheet

In the present embodiment, while the first separator sheet 2 and the negative electrode sheet 3 are separated and collected, the second separator sheet 4 and the positive electrode sheet 5 are separated and collected.

The positive electrode separation step S134 is a step of winding the positive electrode laminate sheet 5S around the peeling roller 153, bending the transfer path R2 of the second separator sheet 4, and separating the second separator sheet 4 and the positive electrode sheet 5. The positive electrode separation step S134 includes a clamp moving step S134a, a roller lowering step S134b, and a clamp re-moving step S134c.

The clamp moving step S134a is a step of moving the pair of second clamps 131. In the clamp moving step S134a, first, the pair of second clamps 131 are moved to the right side of the downstream roller 152 (downstream of the transfer path R2), and the second separator sheet 4 is introduced above the upstream roller 151 and the downstream roller 152 and below the peeling roller 153 (refer to FIG. 13). Then, the pair of second clamps 131 are moved back to the left side (upstream side of the transfer path R2) by a predetermined distance. Therefore, the positive electrode laminate sheet 5S becomes loose and rests on the upstream roller 151 and the downstream roller 152 without tension.

The roller lowering step S134b is a step of lowering the peeling roller 153 below the upstream roller 151 and the downstream roller 152. Therefore, the positive electrode laminate sheet 5S is wound around the peeling roller 153. As a result, as shown in FIG. 14, the transfer path R2 of the second separator sheet 4 is bent into a V-shape by the peeling roller 153. The positive electrode sheet 5 is separated from the second separator sheet 4 by bending of the transfer path R2.

The clamp re-moving step S134c is a step of moving the pair of second clamps 131 to t he right side again. As the pair of second clamps 131 move, the positive electrode sheet 5 is sequentially peeled off at a bent portion R2a of the transfer path R2. The same applies after the device that transfers the second separator sheet 4 is changed to the second transfer unit 140.

The second separator interposing step S135 is a step of moving the second separator sheet 4 downstream from the pair of second nip rollers 141 in the transfer direction of the second separator sheet 4 along the transfer path R2 and interposing the second separator sheet 4 between the second nip rollers 141. The pair of second clamps 131 pass between the pair of second nip rollers 141 and are moved below the pair of second nip rollers 141. Although detailed illustration is omitted, similar to the first separator interposing step S35, in the second separator interposing step S135, the second clamp 131 is positioned further inside the front end and the rear end of the wire 147. When the second separator sheet 4 is introduced between the pair of second nip rollers 141, the clamping cylinder 143 (refer to FIG. 2) is driven, the driven roller 141R is moved to the left side, and the second separator sheet 4 is interposed between the driving roller 141L and the driven roller 141R. When the second separator sheet 4 is interposed, the gripping of the second clamp 131 is released.

The second separator transfer step S136 is a step of rotating the driving roller 141L (that is, rotating the pair of second nip rollers 141), and transferring and drawing out the second separator sheet 4. FIG. 17 is a front view of the second transfer unit 140 and the second separation device 150 while transferring the second separator sheet 4. When the second separator sheet 4 is transferred by the second transfer unit 140, the second separator sheet 4 and the positive electrode sheet 5 are unwound from the electrode body 1, and the second separator sheet 4 and the positive electrode sheet 5 are separated and collected. By the transfer motor 142, the driving roller 141L rotates such that the side facing the driven roller 141R moves downward, and the second separator sheet 4 is transferred in the substantially vertical direction together with the driven roller 141R. Therefore, the second separator sheet 4 is transferred in the substantially vertical direction along the wire 147 that extends in the substantially vertical direction (the tangential direction of the driving roller 141L and the driven roller 141R and the transfer direction of the second separator sheet 4). Since the second separator collection unit 160 (refer to FIG. 3) is disposed below the driving roller 141L and the driven roller 141R, the transferred second separator sheet 4 is collected in the second separator collection unit 160.

Although not shown in FIG. 15, similarly to the movement of the pair of first clamps 31, during the movement of the pair of second clamps 131, the orientation of the pair of second clamps 131 is changed appropriately by the rotation device 132a1. Specifically, in the gripping step S22, the pair of second clamps 131 are oriented such that their tip parts face leftward (refer to FIG. 4). As described above, in the pulling step S31, the pair of second clamps 131 are rotated such that their tip parts face diagonally downward to the left. In the positive electrode separation step S134, the pair of second clamps 131 are rotated 90 degrees counterclockwise in a front view and oriented such that their tip parts face downward (refer to FIG. 13). In the positive electrode separation step S134, the pair of second clamps 131 are rotated 180 degrees clockwise in a front view and oriented such that their tip parts face upward.

As described above, according to the electrode body disassembly device 10 (sheet member transfer device) of the present embodiment, the first nip roller 41 includes the wire 47 that extends in the substantially vertical direction (the tangential direction of the first nip roller 41 and the downstream direction in the transfer direction of the first separator sheet 2). This prevents the first separator sheet 2 from being caught in the rotation of the first nip roller 41 and moving in the circumferential direction of the first nip roller 41. Since the first separator sheet 2 can be continuously drawn out and collected, it is possible to improve the time efficiency for collecting the first separator sheet 2. The same applies to the wire 147 provided in the second nip roller 141.

According to the electrode body disassembly device 10 (sheet member transfer device) of the present embodiment, the wire 47 is a linear member wound around the first nip roller 41 and the pulley 44. Therefore, the contact area between the first separator sheet 2 and the wire 47 is relatively small. Accordingly, it is possible to prevent the first separator sheet 2 to be transferred from being attached to the wire 47 (guide member). Therefore, when the wire 47 (linear member) is used as the guide member, the first separator sheet 2 can be transferred more suitably. The same applies to the wire 147 wound around the second nip roller 141 and the pulley 144.

In the present embodiment, the electrode body disassembly device 10 is disclosed as a sheet member transfer device. The electrode body disassembly device 10 disassembles the electrode body 1 in which the first separator sheet 2 and the second separator sheet 4 as sheet members are wound. Here, the electrode body 1 is accommodated together with the electrolytic solution 240 inside the case 210 (refer to FIG. 1). Therefore, the first separator sheet 2 and the second separator sheet 4 of the removed electrode body 1 are wet with the electrolytic solution 240. When the wet first separator sheet 2 is transferred, the surface tension causes the first separator sheet 2 to be easily caught on the first nip roller 41. The same applies to the second separator sheet 4. Therefore, when the electrode body 1 is disassembled by the electrode body disassembly device 10, it is particularly effective to apply the technology disclosed here. In addition, since the first separator sheet 2 and the second separator sheet 4 can be collected continuously, for example, in recycling of the electrode body 1, compared to when the electrode body 1 is subjected to shredding, separating and the like to collect electrode materials, it is possible to improve the collection rate of the electrode materials.

According to the electrode body disassembly device 10 of the present embodiment, when the first clamp 31 moves below the first nip roller 41, the first clamp 31 is positioned further inside than the front end and the rear end of the wire 47 in the front to rear direction. Therefore, a part of the first separator sheet 2 gripped by the first clamp 31 is prevented from being positioned in front of the front end of the wire 47 and/or being positioned behind the rear end of the wire 47 in the front to rear direction. Accordingly, the first separator sheet 2 can be transferred along the wire 47 more reliably. The same applies to the second clamp 131 and the wire 147.

According to the electrode body disassembly device 10 of the present embodiment, after the negative electrode sheet 3 is peeled off by the scraper 52, the static eliminator 90 eliminates static electricity from the first separator sheet 2. This prevents the first separator sheet 2 from being attached to the first nip roller 41 due to static electricity generated when the negative electrode sheet 3 is peeled off from the first separator sheet 2 and from being caught in the rotation of the first nip roller 41. Therefore, the first separator sheet 2 can be transferred more suitably.

### Other Embodiments

The embodiments of the electrode body disassembly device and the electrode body disassembly method proposed here have been described above. However, the above embodiments are merely examples, and the present invention can be implemented in other modes.

In the above embodiment, the transfer path R1 of the first separator sheet 2 and the transfer path R2 of the second separator sheet 4 branch to the left and right from the electrode body accommodation part 20, but the transfer path R1 of the first separator sheet 2 and the transfer path R2 of the second separator sheet 4 are not particularly limited. The transfer path R1 of the first separator sheet 2 and the transfer path R2 of the second separator sheet 4 branch in opposite directions immediately after the branching, but for example, the negative electrode sheet 3 and the positive electrode sheet 5 may be bent downstream of the branch so that they are collected on the same side.

The configurations of the first movement device 32 and the second movement device 132 are not particularly limited. For example, the first movement device 32 and the second movement device 132 may move the first clamp 31 and the second clamp 131 along a guide rail laid on a predetermined track. The first movement device 32 and the second movement device 132 may include, for example, a multi-axis robot.

In the above embodiment, the first separator sheet 2 and the second separator sheet 4 are transferred by the nip rollers, but the present invention is not limited thereto. For example, the negative electrode sheet 3 or the positive electrode sheet 5 that is interposed between the nip rollers may be transferred.

In the above embodiment, the static eliminator 90 eliminates static electricity of the first separator sheet 2, but it may eliminate static electricity from the second separator sheet 4. For example, the static eliminator 90 may be disposed below the scraper 52, and may be disposed below the second transfer unit 140. In this case, static electricity from each of the first separator sheet 2 and the second separator sheet 4 can be eliminated.

In the above embodiment, the electrode members (the first separator sheet 2 and the second separator sheet 4) are used as the sheet members, but the present invention is not limited thereto. The present invention can be applied to a sheet member transfer device that transfers any sheet member.

In addition, the above embodiments do not limit the present invention unless otherwise specified. In addition, the technology disclosed here can be variously modified. The components and processing operations described here may be appropriately omitted or combined unless a particular problem occurs. This specification includes the disclosures described in the following items.

### Item 1:

A sheet member transfer device, comprising:
a pair of nip rollers that nip a strip-shaped sheet member; and
a drive device that rotates the nip roller and transfers the sheet member,
wherein the nip roller includes a guide member that extends in a tangential direction of the nip roller and in a downstream direction in a transfer direction, in which the sheet member is transferred.

### Item 2:

The sheet member transfer device according to Item 1, including a pair of pulleys provided downstream from the pair of nip rollers in the transfer direction of the sheet member,
wherein the guide member is a linear member wound around the nip rollers and the pulleys.

### Item 3:

An electrode body disassembly device, comprising, with the sheet member being an electrode member used in a secondary battery in which an electrode body, in which a strip-shaped electrode member is wound, and a non-aqueous electrolytic solution are accommodated:
a gripping member that grips the electrode member;
a movement mechanism that moves the gripping member downstream from the pair of nip rollers in the transfer direction along a transfer path in the transfer direction; and
the sheet member transfer device according to Item 1 or 2.

### Item 4:

The electrode body disassembly device according to Item 3, wherein, when the gripping member is moved downstream from the pair of nip rollers in the transfer direction, in an axis direction of the pair of nip rollers, the gripping member is disposed further inside than an end of the guide member in the axis direction.

### Item 5:

The electrode body disassembly device according to Item 3 or 4, comprising, with the electrode member including a positive electrode sheet, a negative electrode sheet and a separator:
a scraper that is provided on the transfer path and peels the negative electrode sheet off from the separator; and
a static eliminator that is provided downstream from the scraper in the transfer direction, and eliminates static electricity from the separator from which the negative electrode sheet has been peeled off.

### Item 6:

A sheet member transfer method, including:
a preparation step of preparing a strip-shaped sheet member;
a step of interposing the sheet member between a pair of nip rollers; and
a step of rotating the nip roller and transferring the sheet member,
wherein the nip roller includes a guide member that extends in a tangential direction of the nip roller and in a downstream direction in a transfer direction in which the sheet member is transferred, and
in the step of transferring the sheet member, the sheet member is transferred along the guide member.

### Item 7:

The sheet member transfer method according to Item 6, further including, with the sheet member that is prepared in the preparation step being an electrode member used in a secondary battery in which an electrode body, in which a strip-shaped electrode member is wound, and a non-aqueous electrolytic solution are accommodated:
a step of gripping the electrode member; and
a step of moving, along a predetermined transfer path, the electrode member downstream from the pair of nip rollers on the transfer path.

### Item 8:

The sheet member transfer method according to Item 7, further including, with the electrode member that is prepared in the preparation step including a positive electrode sheet, a negative electrode sheet, and a separator:
a step of transferring the negative electrode sheet and the separator along the transfer path, and peeling the negative electrode sheet off from the separator; and
a step of eliminating static electricity from the separator from which the negative electrode sheet has been peeled off.

What is claimed is:

1. A sheet member transfer device, comprising:
a pair of nip rollers that nip a strip-shaped sheet member; and
a drive device that rotates the nip roller and transfers the sheet member,
wherein the nip roller includes a guide member that extends in a tangential direction of the nip roller and in a downstream direction in a transfer direction, in which the sheet member is transferred.

2. The sheet member transfer device according to claim 1, comprising a pair of pulleys provided downstream from the pair of nip rollers in the transfer direction of the sheet member,
wherein the guide member is a linear member wound around the nip rollers and the pulleys.

3. An electrode body disassembly device, comprising, with the sheet member being an electrode member used in a secondary battery in which an electrode body, in which a strip-shaped electrode member is wound, and a non-aqueous electrolytic solution are accommodated:
a gripping member that grips the electrode member;
a movement mechanism that moves the gripping member downstream from the pair of nip rollers in the transfer direction along a transfer path in the transfer direction; and
the sheet member transfer device according to claim 1.

4. The electrode body disassembly device according to claim 3, wherein, when the gripping member is moved downstream from the pair of nip rollers in the transfer direction, in an axis direction of the pair of nip rollers, the gripping member is disposed further inside than an end of the guide member in the axis direction.

5. The electrode body disassembly device according to claim 3, comprising, with the electrode member including a positive electrode sheet, a negative electrode sheet and a separator:
a scraper that is provided on the transfer path and peels the negative electrode sheet off from the separator; and
a static eliminator that is provided downstream from the scraper in the transfer direction, and eliminates static electricity from the separator from which the negative electrode sheet has been peeled off.

6. A sheet member transfer method, including:
a preparation step of preparing a strip-shaped sheet member;
a step of interposing the sheet member between a pair of nip rollers; and
a step of rotating the nip roller and transferring the sheet member,
wherein the nip roller includes a guide member that extends in a tangential direction of the nip roller and in a downstream direction in a transfer direction in which the sheet member is transferred, and
in the step of transferring the sheet member, the sheet member is transferred along the guide member.

7. The sheet member transfer method according to claim 6, further including, with the sheet member that is prepared in the preparation step being an electrode member used in a secondary battery in which an electrode body, in which a strip-shaped electrode member is wound, and a non-aqueous electrolytic solution are accommodated:
a step of gripping the electrode member; and
a step of moving, along a predetermined transfer path, the electrode member downstream from the pair of nip rollers on the transfer path.

8. The sheet member transfer method according to claim 7, further including, with the electrode member that is prepared in the preparation step including a positive electrode sheet, a negative electrode sheet, and a separator:
a step of transferring the negative electrode sheet and the separator along the transfer path, and peeling the negative electrode sheet off from the separator; and
a step of eliminating static electricity from the separator from which the negative electrode sheet has been peeled off.
